(19) United States
(12) Patent Application Publication
(10) Pub. No.: US 2007/0186081 A1
(43) Pub. Date: Aug. 9, 2007

(54) Supporting out-of-order issue in an execute-ahead processor

(76) Inventors: Shailender Chaudhry, San Francisco, CA (US); Marc Tremblay, Menlo Park, CA (US); Paul Caprioli, Mountain View, CA (US)

Correspondence Address: SUN MICROSYSTEMS INC.;C/O PARK, VAUGHAN & FLEMING LLP, 2820 FIFTH STREET, DAVIS, CA, 95618-7759, US

(21) Appl. No.: 11/367,814

(22) Filed: Mar. 3, 2006

Related U.S. Application Data
(63) Continuation of application No. 60/765,842, filed on Feb. 6, 2006.

(51) Int. Cl. G06F 9/30

(52) U.S. Cl. 712/214; 712/228

(57) ABSTRACT

One embodiment of the present invention provides a system which supports out-of-order issue in a processor that normally executes instructions in-order. The system starts by issuing instructions from an issue queue in program order during a normal-execution mode. While issuing the instructions, the system determines if any instruction in the issue queue has an unresolved short-latency data dependency which depends on a short-latency operation. If so, the system generates a checkpoint and enters an out-of-order-issue mode, wherein instructions in the issue queue with unresolved short-latency data dependencies are held and not issued, and wherein other instructions in the issue queue without unresolved data dependencies are allowed to issue out-of-order.

### RELATED APPLICATION

This application hereby claims priority under 35 U.S.C. §119 to U.S. Provisional Patent Application No. 60/765,842, filed on 6 Feb. 2006, entitled “Supporting Out-of-Order Issue in an Execute-Ahead Processor,” by inventors Shailender Chaudhry, Marc Tremblay and Paul Caprioli (Attorney Docket No. SUN05-1055PSP).

### BACKGROUND

1. Field of the Invention

The present invention relates to techniques for improving the performance of computer systems. More specifically, the present invention relates to a method and apparatus for supporting out-of-order issue in an execute-ahead processor.

2. Related Art

Advances in semiconductor fabrication technology have given rise to dramatic increases in microprocessor clock speeds. This increase in microprocessor clock speeds has not been matched by a corresponding increase in memory access speeds. Hence, the disparity between microprocessor clock speeds and memory access speeds continues to grow, and is beginning to create significant performance problems. Execution profiles for fast microprocessor systems show that a large fraction of execution time is spent not within the microprocessor core, but within memory structures outside of the microprocessor core. This means that the microprocessor systems spend a large fraction of time waiting for memory references to complete instead of performing computational operations.

Efficient caching schemes can help reduce the number of memory accesses that are performed. However, when a memory reference, such as a load operation generates a cache miss, the subsequent access to level-two (L2) cache or memory can require dozens or hundreds of clock cycles to complete, during which time the processor is typically idle, performing no useful work.

A number of techniques are presently used (or have been proposed) to hide this cache-miss latency. Some processors support out-of-order execution, in which instructions are kept in an issue queue, and are issued “out-of-order” when operands become available. Unfortunately, existing out-of-order designs have a hardware complexity that grows quadratically with the size of the issue queue. Practically speaking, this constraint limits the number of entries in the issue queue to one or two hundred, which is not sufficient to hide memory latencies as processors continue to get faster. Moreover, constraints on the number of physical registers which are available for register renaming purposes during out-of-order execution also limits the effective size of the issue queue.

Some processor designers have proposed entering a “scout mode” during processor stall conditions. In scout mode, instructions are speculatively executed to prefetch future loads, but results are not committed to the architectural state of the processor. For example, see U.S. patent application Ser. No. 10/741,944, filed 19 Dec. 2003, entitled, “Generating Prefetches by Speculatively Executing Code through Hardware Scout Threading,” by inventors Shailender Chaudhry and Marc Tremblay (Attorney Docket No. SUN-P8383-MEG). This solution to the latency problem eliminates the complexity of the issue queue and the rename unit, and also achieves memory-level parallelism. However, it suffers from the disadvantage of having to re-compute results of computational operations that were performed in scout mode.

To avoid performing these re-computations, processor designers have proposed entering an “execute-ahead” mode, wherein instructions that cannot be executed because of unresolved data dependencies are deferred, and wherein other non-deferred instructions are executed in program order. When an unresolved data dependency is ultimately resolved during execute-ahead mode, the system executes deferred instructions in a “deferred mode,” wherein deferred instructions that able to be executed are executed in program order, and wherein other deferred instructions that still cannot be executed because of unresolved data dependencies are deferred again. For example, see U.S. patent application Ser. No. 10/686,061, filed 14 Oct. 2003, entitled, “Selectively Deferring the Execution of Instructions with Unresolved Data Dependencies as They Are Issued in Program Order,” by inventors Shailender Chaudhry and Marc Tremblay (Attorney Docket No. SUN04-0182-MEG).

One problem with existing processor designs that support execute-ahead mode and scout mode is that instructions which do not have long-latency data dependencies are constrained to execute “in-order” while the processor is operating in normal-execution mode. This can adversely affect performance because when a current instruction cannot issue because of a multi-cycle short-latency data dependency (such as a load-hit, an integer multiply or a floating-point computation), no subsequent instructions can issue. Consequently, a delay in a given instruction can affect subsequent instructions that may be entirely unrelated to the given instruction (for example, when the subsequent instructions are from a separate execution thread).

Hence, what is needed is a method and apparatus which facilitates the executing instructions in a processor that supports execute-ahead mode and/or scout mode without the above-described performance problems.

### SUMMARY

One embodiment of the present invention provides a system which supports out-of-order issue in a processor that normally executes instructions in-order. The system starts by issuing instructions from an issue queue in program order during a normal-execution mode. While issuing the instructions, the system determines if any instruction in the issue queue has an unresolved short-latency data dependency which depends on a short-latency operation. If so, the system generates a checkpoint and enters an out-of-order-issue mode, wherein instructions in the issue queue with unresolved short-latency data dependencies are held and not issued, and wherein other instructions in the issue queue without unresolved data dependencies are allowed to issue out-of-order.

In a variation of this embodiment, the issue queue includes an entry for each pipeline in the processor, and during out-of-order-issue mode, as instructions are issued and cause corresponding entries in the issue queue become free, following instructions are placed in the free entries.

In a further variation, the system halts the out-of-order issuance of instructions from an entry in the issue queue when the number of instructions issued from that entry exceeds a maximum value.

In a further variation, the system allows a held instruction to issue when a data dependency for the held instruction is resolved.

In a further variation, the system returns to normal-execution mode from out-of-order-issue mode when all held instructions are issued.

In a further variation, if an exception occurs in out-of-order-issue mode, the system resumes normal-execution mode from the checkpoint.

In a variation of this embodiment, during execution of an instruction in normal-execution mode or out-of-order-issue mode, if an instruction is encountered which depends upon a long-latency operation (a “launch-point instruction”), the system generates a checkpoint if the processor is currently in normal-execution mode. The system then enters execute-ahead mode, wherein instructions that cannot be executed because of an unresolved long-latency data dependency are deferred, wherein instructions in the issue queue with unresolved short-latency data dependencies are held and not issued, and wherein other instructions in the issue queue without unresolved data dependencies are allowed to issue out-of-order.

In a variation of this embodiment, if an unresolved data long-latency dependency is resolved during execute-ahead mode, the system executes deferred instructions in a deferred-execution mode, wherein deferred instructions that still cannot be executed because of unresolved long-latency data dependencies are deferred again, wherein instructions in the issue queue with unresolved short-latency data dependencies are held and not issued, and wherein other instructions in the issue queue without unresolved data dependencies are allowed to issue out-of-order. If some deferred instructions are re-deferred during the deferred-execution mode, the system returns to execute-ahead mode at the point where execute-ahead mode left off. Otherwise, if all deferred instructions are executed in the deferred-execution mode, the system returns to normal-execution mode to resume normal program execution.

In a further variation, during execution of an instruction in normal-execution mode or out-of-order-issue mode, if a non-data dependent stall condition is encountered, the system generates a checkpoint if the processor is currently in normal-execution mode. The system then enters scout mode, wherein instructions are speculatively executed to prefetch future loads, but wherein results are not committed to the architectural state of the processor.

### BRIEF DESCRIPTION OF THE FIGURES

FIG. 1 illustrates the design of a processor that supports speculative-execution in accordance with an embodiment of the present invention.

FIG. 2 presents a state diagram which includes a depiction of normal-execution mode, scout mode, execute-ahead mode, deferred mode, and out-of-order mode in accordance with an embodiment of the present invention.

FIG. 3 presents a flow chart illustrating out-of-order issue in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

Processor

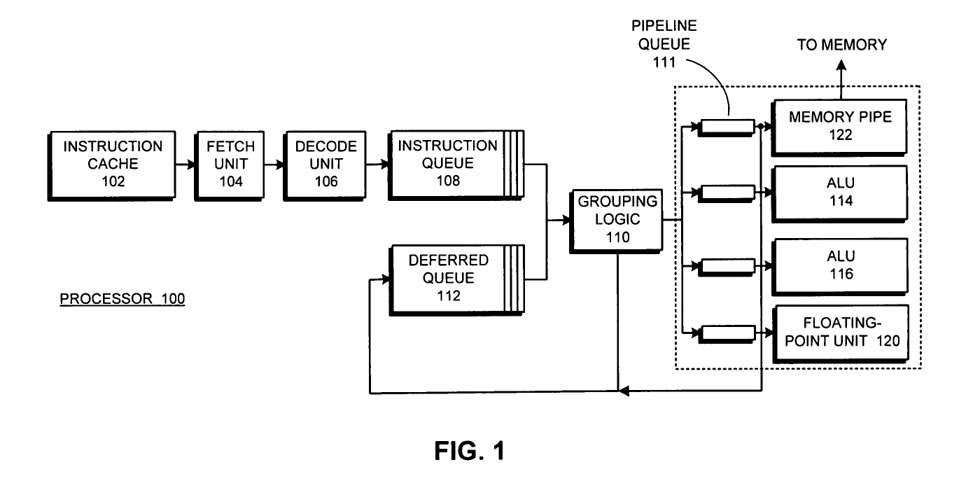

FIG. 1 illustrates the design of a processor 100 that supports speculative-execution in accordance with an embodiment of the present invention. Processor 100 can generally include any type of processor, including, but not limited to, a microprocessor, a mainframe computer, a digital signal processor, a personal organizer, a device controller, and a computational engine within an appliance. As is illustrated in FIG. 1, processor 100 includes: instruction cache 102, fetch unit 104, decode unit 106, instruction queue 108, grouping logic 110, deferred queue 112, arithmetic logic unit (ALU) 114, ALU 116, and floating point unit (FPU) 120.

Processor 100 also includes four pipeline queues 111. Each pipeline queue 111 serves as a first-in-first-out (“FIFO”) queue for an execution unit. Hence, there is a pipeline queue 111 corresponding to memory pipe 122 (for accessing remote memory), ALU 114, ALU 116, and FPU 120. Processor 100 buffers instructions in pipeline queues 111 before feeding the instructions into the corresponding execution units. In the following examples the pipeline queues 111 have only one entry and function simply as a buffer between grouping logic 110 and the execution units. However, in an alternative embodiment, the pipeline queues may have more than one entry and may function as a queue.

During operation, fetch unit 104 retrieves instructions to be executed from instruction cache 102 and feeds these instructions into decode unit 106. Decode unit 106 decodes the instructions and forwards the decoded instructions to instruction queue 108, which is organized as a FIFO queue. Next, instruction queue 108 feeds a batch of decoded instructions into grouping logic 110, which sorts the instructions and forwards each instruction to the pipeline queue 111 corresponding to the execution unit that can handle the execution of the instruction. From pipeline queue 111, the instructions feed to the individual execution units for execution.

In addition to sorting the instructions, grouping logic 110 checks each instruction for unresolved data dependencies. Unresolved data dependencies occur when an instruction requires read or write access to a register that is not yet available. For one embodiment of the present invention, data dependencies are classified as “long-latency” or “short-latency.” A long-latency data dependency is a dependency that is many cycles in duration. In other words, one or more of the registers required to complete the execution of the dependent instruction is not available for many cycles. For example, an instruction that depends on a LOAD instruction which has encountered an L1 miss requiring a 50 cycle L2 LOAD request has a long-latency dependency. On the other hand, a short-latency dependency is a dependency that is small number of cycles in duration. For example, a “use” instruction which depends on the immediately preceding LOAD (that hits in the L1) with a duration of 2-3 cycles has a short-latency dependency.

Although “long-latency” and “short-latency” dependencies are used to group instructions in the following examples, alternative embodiments are envisioned which use other schemes to group instructions with data dependencies. For example, instructions may be grouped by the particular type of instruction which created the dependency (such as a LOAD instruction which encounters an L1 miss).

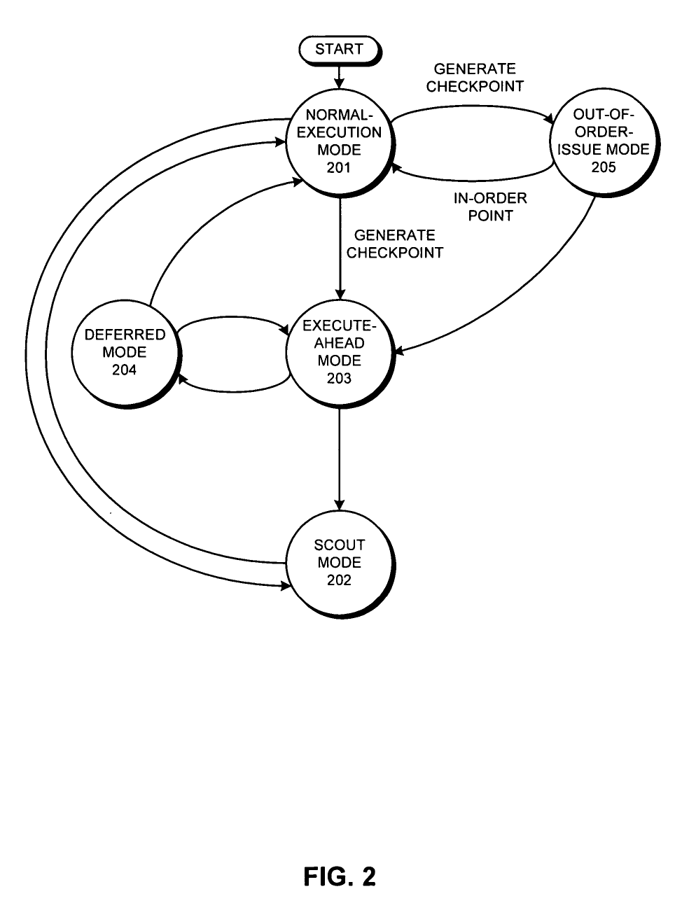

If processor 100 encounters an instruction with an unresolved long-latency data dependency while operating in normal-execution mode 201 (see FIG. 2), processor 100 generates a checkpoint and enters execute-ahead mode 203. In execute-ahead mode, instructions that cannot be executed because of a long-latency data dependency are deferred, instructions in the issue queue with unresolved short-latency data dependencies are held and not issued, and other instructions in the issue queue without unresolved data dependencies are allowed to issue out-of-order. Note that processor 100 stores deferred instructions in deferred queue 112 until the data dependency is resolved, at which time processor 100 enters deferred mode 204 and executes the deferred instructions.

If processor 100 encounters an instruction with an unresolved short-latency data dependency while operating in normal-execution mode 201, processor 100 generates a checkpoint and enters out-of-order-issue mode 205. During out-of-order-issue mode 205, processor 100 issues the current batch of instructions to pipeline queues 111, but halts any instruction with an unresolved short-latency data dependency in pipeline queues 111 (thereby preventing the instruction from entering the execution unit). Instructions with no unresolved data dependencies continue through the pipeline queues 111 to the execution units.

Processor 100 then continues to issue batches of instructions from grouping logic 110 to the pipeline queues 111 with each cycle. Processor 100 continues to hold on any existing instruction with unresolved short-latency data dependencies in a pipeline queue 111. In addition, processor 100 halts any newly issued instruction with an unresolved short-latency data dependency at the corresponding pipeline queue 111. Otherwise, instructions with no unresolved data dependencies proceed through the pipeline queues 111 and to the execution units.

Note that processor 100 continues to issue instructions with no unresolved short-latency data dependencies from a pipeline queue 111 in out-of-order-issue mode 205 until a predetermined number of instructions has issued from the pipeline queue 111 while another pipeline queue 111 is being held. For example, in one embodiment of the present invention, a maximum of 64 instructions can issue from a pipeline queue 111 while another pipeline queue 111 is being held. If the number of instructions issued out-of-order exceeds this value, processor 100 halts the offending pipeline queue 111 until the previously halted pipeline queue 111 begins to issue instructions.

If processor 100 encounters an instruction with an unresolved long-latency data dependency while operating in out-of-order-issue mode 205, processor 100 leaves out-of-order-issue mode 205 and enters execute-ahead mode 203. Despite transitioning from out-of-order-issue mode 205 to execute-ahead mode 203, processor 100 continues to use the checkpoint originally generated upon entering out-of-order-issue mode 205. The checkpoint can be used in this way because the checkpoint used for out-of-order-issue mode 205 is identical to the checkpoint that is used for execute-ahead mode 203.

If processor 100 encounters an exception during operation in out-of-order-issue mode 205, processor 100 restores the checkpoint and resumes operation in normal-execution mode 201. In an alternative embodiment, processor 100 does not resume operating in normal-execution mode 201, but instead retains the checkpoint and transitions to scout mode 202. In scout mode 202, processor 100 speculatively executes instructions to prefetch future loads, but does not commit the results to the architectural state of processor 100. Scout mode 202 is described in more detail in a pending U.S. patent application entitled, “Generating Prefetches by Speculatively Executing Code Through Hardware Scout Threading,” by inventors Shailender Chaudhry and Marc Tremblay, having Ser. No. 10/741,944, and filing date 19 Dec. 2003, which is hereby incorporated by reference to describe implementation details of scout mode 202.

When a short-latency data dependency is resolved in out-of-order-issue mode 205, processor 100 allows the halted dependent instruction to feed from pipeline queue 111 into the corresponding execution unit. When all existing short-latency data dependencies are resolved and all held instructions in the pipeline queues 111 are issued, processor 100 discards the checkpoint and resumes normal-execution mode 201.

Speculative-Execution State Diagram

FIG. 2 presents a state diagram which illustrates normal-execution mode 201, scout mode 202, execute-ahead mode 203, deferred mode 204, and out-of-order-issue mode 205 in accordance with an embodiment of the present invention.

Processor 100 starts in normal-execution mode 201, wherein processor 100 executes instructions in program order as they are issued from instruction queue 108 (see FIG. 1).

If a short-latency data-dependent stall condition (unresolved data dependency) arises during the execution of an instruction in normal-execution mode 201, processor 100 transitions to out-of-order-issue mode 205. A short-latency data dependent stall condition can include, for example: the use of an operand that has not returned from a preceding load hit; the use of a result from an immediately proceeding instruction; or the use of an operand that depends on another operand that is subject to a short-latency unresolved data dependency.

While moving to out-of-order-issue mode 205, processor 100 generates a checkpoint that can be used, if necessary, to return execution to the point (the “launch point”) where the data-dependent stall condition was encountered. Generating this checkpoint involves saving the precise architectural state of processor 100 to facilitate subsequent recovery from exceptions that arise during out-of-order-issue mode 205.

While operating in out-of-order-issue mode 205, processor 100 allows the current batch of instructions to issue from grouping logic 110 to pipeline queues 111. Processor 100 then halts any pipeline queues 111 with an instruction with a short-latency data-dependency, but allows instructions without data-dependencies to continue through the pipeline queues 111 to the corresponding execution units.

Processor then continues to issue batches of instructions to pipeline queues 111 in out-of-order-issue mode 205. As with the first batch of instructions, processor 100 halts the pipeline queue 111 for each instruction that encounters a short-latency data-dependency, while allowing instructions without data-dependencies to pass to the corresponding execution units.

When a short-latency data-dependency is resolved, processor 100 removes the halt on the pipeline queue 111 and allows the previously-halted instruction to enter the corresponding execution unit. When all existing data short-latency dependencies are resolved and all held instructions in the pipeline queues 111 are issued, processor 100 discards the checkpoint and resumes normal-execution mode 201.

If an exception arises while processor 100 is operating in out-of-order-issue mode 205, processor 100 restores the checkpoint (thereby returning the processor to the condition prior to the launch instruction) and resumes execution in normal-execution mode 201. In an alternative embodiment, processor 100 does not resume operating in normal-execution mode 201, but instead retains the checkpoint and transitions to scout mode 202. In scout mode 202, processor 100 speculatively executes instructions to prefetch future loads, but does not commit the results to the architectural state of processor 100.

If a long-latency data-dependent stall condition (unresolved data dependency) arises during the execution of an instruction in normal-execution mode 201 or out-of-order-issue mode 205, processor 100 transitions back to execute-ahead mode 203. A long-latency data-dependent stall condition can include: a use of an operand that has not returned from a preceding load miss; a use of an operand that has not returned from a preceding translation lookaside buffer (TLB) miss; a use of an operand that has not returned from a preceding full or partial read-after-write (RAW) from store buffer operation; and a use of an operand that depends on another operand that is subject to an unresolved data dependency.

While moving to execute-ahead mode 203 from normal-execution mode 201, processor 100 generates a checkpoint that can be used, if necessary, to return execution to the point (the “launch point”) where the long-latency data-dependent stall condition was encountered. Generating this checkpoint involves saving the precise architectural state of processor 100 to facilitate subsequent recovery from exceptions that arise during execute-ahead mode 203. On the other hand, processor 100 does not generate a checkpoint when transitioning from out-of-order-issue mode 205 to execute-ahead mode 203. The checkpoint is unnecessary because the checkpoint originally generated upon entering to out-of-order-issue mode 205 from normal-execution mode 201 serves as the checkpoint for execute-ahead mode 203. Processor 100 then “defers” execution of the instruction that encountered the unresolved long-latency data dependency (“launch instruction”) by storing the instruction in deferred queue 112.

While operating in execute-ahead mode 203, processor 100 continues to execute instructions as they are received from instruction queue 108. In doing so, instructions with an unresolved long-latency data dependency are deferred, instructions in the issue queue with unresolved short-latency data dependencies are held and not issued, and other instructions in the issue queue without unresolved data dependencies are allowed to issue out-of-order.

Processor 100 may handle short-latency data dependent instructions in two ways during execute-ahead mode 203. First, processor 100 may halt instructions with short-latency data-dependencies at pipeline queues 111 (as is done in out-of-order-issue mode 205). For this scheme, processor 100 removes the hold and allows the dependent instruction to enter the execution unit after the short-latency dependency is resolved. Second, processor 100 may allow the dependent instruction to pass through the pipeline queue 111, but halt the execution unit until the dependency is resolved. For this scheme, the data is passed directly to the execution unit upon arrival and the execution unit is allowed to resume operation.

When a data dependency for a long-latency deferred instruction is resolved during execute-ahead mode 203, processor 100 leaves execute-ahead mode 203 and commences execution in deferred mode 204. In deferred mode 204, processor 100 attempts to execute each of the deferred instructions in deferred queue 112. In doing so, deferred instructions that still cannot be executed because of unresolved long-latency data dependencies are deferred again, instructions in the issue queue with unresolved short-latency data dependencies are held and not issued, and other instructions in the issue queue without unresolved data dependencies are allowed to issue out-of-order. During deferred mode 204, processor 100 re-defers execution of deferred instructions that still cannot be executed because of unresolved long-latency data dependencies by placing the re-deferred instructions back into deferred queue 112 (not necessarily in program order).

After processor 100 completes a pass through deferred queue 112 in deferred mode 204, some re-deferred instructions may remain to be executed. If so, processor 100 resumes execute-ahead mode 203 and waits for another data return to commence executing the re-deferred instructions. When another data return occurs, processor 100 leaves execute-ahead mode 203 and commences execution in deferred mode 204, making another pass through deferred queue 112. Processor 100 continues to make passes through deferred queue 112 in this way until all the deferred instructions in deferred queue 112 have been executed. When the deferred instructions have all been executed, processor 100 discards the checkpoint and returns to normal-execution mode 201.

If a non-data dependent stall condition, such as a memory barrier operation or a deferred queue full condition, arises while processor 100 is in normal-execution mode 201 or execute-ahead mode 203, processor 100 generates a checkpoint and moves into scout mode 202. In scout mode 202, processor 100 speculatively executes instructions to prefetch future loads, but does not commit the results to the architectural state of processor 100.

When the non-data dependent stall condition clears, processor 100 restores the checkpoint and resumes execution in normal-execution mode 201.

The Out-of-Order Issue Process

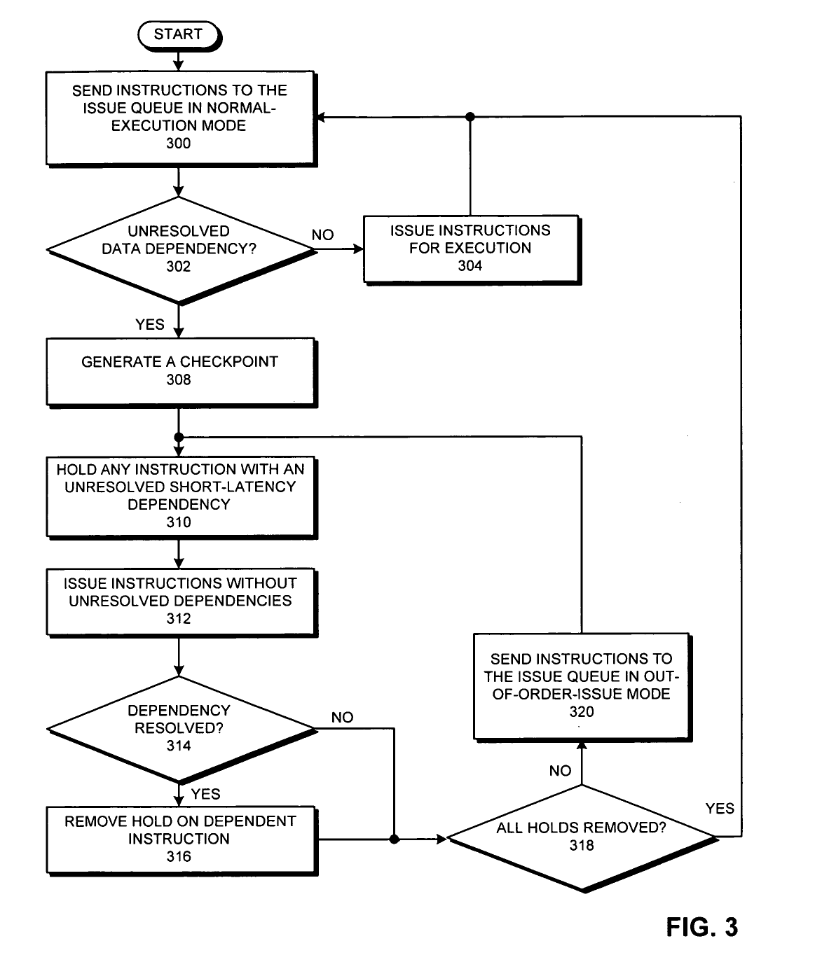

FIG. 3 presents a flow chart illustrating out-of-order issue in accordance with an embodiment of the present invention. The process starts when processor 100 sends a batch of instructions from decode unit 106 (see FIG. 1) to instruction queue 108 in normal-execution mode 201 (step 300). From instruction queue 108, the batch of instructions feeds into grouping logic 110. In grouping logic 110, processor 100 determines if there are any instructions in the batch with unresolved data dependencies (step 302). If not, processor 100 issues the batch of instructions for execution (step 304). Processor 100 then returns to step 300 to send the next batch of instructions from decode unit 106 to instruction queue 108 in normal-execution mode 201.

If there are unresolved data dependencies, processor 100 enters out-of-order-issue mode 205. Processor 100 determines that there has not yet been a checkpoint generated (step 306) and generates a checkpoint (step 308). The checkpoint facilitates returning to normal-execution mode 201 at the launch instruction in the event of an exception.

Processor 100 then allows the batch of instructions to feed into the pipeline queues 111. In doing so, processor 100 halts the pipeline queue 111 for any instructions with unresolved short-latency data dependencies (step 310), thereby preventing the instruction from issuing to the execution units. On the other hand, processor 100 allows instructions without unresolved data dependencies proceed through pipeline queues 111 and into the execution units (step 312).

Processor 100 next determines if a short-latency data dependency has been resolved for any of the held instructions (the instructions held in the pipeline queues 111) (step 314). If so, processor 100 removes the hold on any instruction in the pipeline queues 111 that previously depended on the data (step 316). Processor 100 then determines if all holds have been removed (step 318), which means that all previously unresolved short-latency data dependencies have been resolved.

If instructions are still being held in pipeline queues 111, processor 100 issues the next batch of instructions in out-of-order-issue mode 205 (step 320). Otherwise, processor 100 returns to step 300 to resume normal-execution mode 201.

If an exception condition arises during out-of-order-issue mode, the system uses the checkpoint to return to normal-execution mode. During this process, any remaining “held instructions” can be: (1) killed; (2) released without regard to whether their dependencies are satisfied; or (3) can remain held until their dependencies are naturally satisfied. (Note that “held instructions” can be processed in the same way when the system uses a checkpoint to return from scout mode to normal-execution mode.)

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

1. A method for supporting out-of-order issue in a processor, comprising:
issuing instructions from an issue queue in an in-order processor in program order during a normal-execution mode;
while issuing the instructions, determining if any instruction in the issue queue has an unresolved data short-latency dependency which depends on a short-latency operation; and
if so, generating a checkpoint and entering an out-of-order-issue mode, wherein instructions in the issue queue with unresolved short-latency data dependencies are held and not issued, and wherein other instructions in the issue queue without unresolved data dependencies are allowed to issue out-of-order.

2. The method of claim 1,
wherein the issue queue includes an entry for each pipeline in the processor; and
wherein during out-of-order-issue mode, as instructions are issued and cause corresponding entries in the issue queue become free, following instructions are placed in the free entries.

3. The method of claim 2, further comprising halting out-of-order issuance of instructions from an entry in the issue queue when the number of instructions issued from that entry exceeds a maximum value.

4. The method of claim 3, further comprising allowing a held instruction to issue when a data dependency for that instruction is resolved.

5. The method of claim 4, further comprising returning to a normal-execution mode from out-of-order-issue mode when all held instructions are issued.

6. The method of claim 1, wherein if an exception occurs in out-of-order-issue mode, the method further comprises resuming normal-execution mode from the checkpoint.

7. The method of claim 1, wherein during execution of an instruction in normal-execution mode or out-of-order-issue mode, if an instruction is encountered which depends upon a long-latency operation (a “launch-point instruction”), the method further comprises:
generating a checkpoint if the processor is currently in normal-execution mode, and
entering an execute-ahead mode, wherein instructions that cannot be executed because of an unresolved long-latency data dependency are deferred, wherein instructions in the issue queue with unresolved short-latency data dependencies are held and not issued, and wherein other instructions in the issue queue without unresolved data dependencies are allowed to issue out-of-order.

8. The method of claim 7,
wherein if an unresolved long-latency data dependency is resolved during execute-ahead mode, the method further involves executing deferred instructions in a deferred-execution mode, wherein deferred instructions that still cannot be executed because of unresolved long-latency data dependencies are deferred again, wherein instructions in the issue queue with unresolved short-latency data dependencies are held and not issued, and wherein other instructions in the issue queue without unresolved data dependencies are allowed to issue out-of-order;
wherein if some deferred instructions are deferred again during the deferred-execution mode, the method further involves returning to execute-ahead mode at the point where execute-ahead mode left off; and
wherein if all deferred instructions are executed in the deferred-execution mode, the method further involves returning to the normal-execution mode to resume normal program execution.

9. The method of claim 1, wherein during execution of an instruction in normal-execution mode or out-of-order-issue mode, if a non-data dependent stall condition is encountered, the method further comprises:
generating a checkpoint if the processor is currently in normal-execution mode; and
entering a scout mode, wherein instructions are speculatively executed to prefetch future loads, but wherein results are not committed to the architectural state of the processor.

10. An apparatus for out-of-order issue in a processor, comprising:
a memory coupled to the processor, wherein data and instructions used during the operation of the processor are stored in and retrieved from the memory;
an in-order execution mechanism on the processor;
an issue queue with an entry for each of a plurality of pipelines on the processor;
wherein the execution mechanism is configured to issue instructions from the issue queue to the pipelines in program order during a normal-execution mode;
while issuing the instructions, the execution mechanism is configured to determine if any instruction in the issue queue has an unresolved short-latency data dependency which depends on a short-latency operation; and
if so, the execution mechanism is configured to generate a checkpoint and enter an out-of-order-issue mode, wherein instructions in the issue queue with unresolved short-latency data dependencies are held and not issued, and wherein other instructions in the issue queue without unresolved data dependencies are allowed to issue out-of-order.

11. The apparatus of claim 10, wherein during out-of-order-issue mode, as instructions are issued and cause corresponding entries in the issue queue become free, the execution mechanism is configured to place a following instruction in each free entry.

12. The apparatus of claim 11, wherein the execution mechanism is configured to halt out-of-order issuance of instructions from an entry in the issue queue when the number of instructions issued from that entry exceeds a maximum value.

13. The apparatus of claim 12, wherein the execution mechanism is configured to allow a held instruction to issue when a data dependency for that instruction is resolved.

14. The apparatus of claim 13, wherein the execution mechanism is configured to return to a normal-execution mode from out-of-order-issue mode when all held instructions are issued.

15. The method of claim 10, wherein if an exception occurs in out-of-order-issue mode, the execution mechanism is configured to resume normal-execution mode from the checkpoint.

16. The apparatus of claim 10, wherein during execution of an instruction in normal-execution mode or out-of-order-issue mode, if an instruction is encountered which depends upon a long-latency operation (a “launch-point instruction”), the execution mechanism is configured to:
generate a checkpoint if the processor is currently in normal-execution mode, and
enter an execute-ahead mode, wherein instructions that cannot be executed because of an unresolved long-latency data dependency are deferred, wherein instructions in the issue queue with unresolved short-latency data dependencies are held and not issued, and wherein other instructions in the issue queue without unresolved data dependencies are allowed to issue out-of-order.

17. The apparatus of claim 16,
wherein if the unresolved long-latency data dependency is resolved during execute-ahead mode, the execution mechanism is configured to execute deferred instructions in a deferred-execution mode, wherein deferred instructions that still cannot be executed because of unresolved long-latency data dependencies are deferred again, wherein instructions in the issue queue with unresolved short-latency data dependencies are held and not issued, and wherein other instructions in the issue queue without unresolved data dependencies are allowed to issue out-of-order;
wherein if some deferred instructions are deferred again during the deferred-execution mode, the execution mechanism is configured resume to execute-ahead mode at the point where execute-ahead mode left off; and
wherein if all deferred instructions are executed in the deferred-execution mode, the execution mechanism is configured to resume normal program execution at the point where execute-ahead mode left off.

18. The apparatus of claim 10, wherein during execution of an instruction in normal-execution mode or out-of-order-issue mode, if a non-data dependent stall condition is encountered, the execution mechanism is configured to:
generate a checkpoint if the processor is currently in normal-execution mode; and
enter a scout mode, wherein instructions are speculatively executed to prefetch future loads, but wherein results are not committed to the architectural state of the processor.

19. A computer system that performs out-of-order issue in a processor, comprising:
a memory coupled to the processor, wherein data and instructions used during the operation of the processor are stored in and retrieved from the memory;
an in-order execution mechanism on the processor;
an issue queue with an entry for each of a plurality of pipelines on the processor;
wherein the execution mechanism is configured to issue instructions from the issue queue to the pipelines in program order during a normal-execution mode;
while issuing the instructions, the execution mechanism is configured to determine if any instruction in the issue queue has an unresolved short-latency data dependency which depends on a short-latency operation; and
if so, the execution mechanism is configured to generate a checkpoint and enter an out-of-order-issue mode, wherein instructions in the issue queue with unresolved short-latency data dependencies are held and not issued, and wherein other instructions in the issue queue without unresolved data dependencies are allowed to issue out-of-order.
